(19) United States
(12) Patent Application Publication
(10) Pub. No.: US 2015/0294611 A1
(43) Pub. Date: Oct. 15, 2015

(54) DISPLAYING METHOD AND DRIVING DEVICE OF LCD PANEL AND LCD DEVICE

(71) Applicant: Shenzhen China Star Optoelectronics Technology Co., Ltd., Shenzhen, Guangdong (CN)

(72) Inventors: Hua Zheng, Shenzhen (CN); Jinbo Guo, Shenzhen (CN)

(73) Assignee: Shenzhen China Star Optoelectronics Technology Co., Ltd., Shenzhen, Guangdong (CN)

(21) Appl. No.: 14/373,343

(22) PCT Filed: Jan. 9, 2014
(86) PCT No.: PCT/CN2014/070393

§ 371 Date: Jul. 18, 2014

(30) Foreign Application Priority Data
Dec. 31, 2013 (CN) 201310747837.8

(51) Int. Cl. G09G 3/20; G09G 3/36

(52) U.S. Cl. CPC G09G 3/2003; G09G 3/3648; G09G 3/3674; G09G 3/3685; G09G 3/3614; G09G 3/3607; G09G 2230/00; G09G 2300/0452; G09G 2320/0233; G09G 2320/0242

(57) ABSTRACT

A displaying method of an LCD panel includes: dividing pixel units of the LCD panel into groups on row basis; realizing an allocation condition of colors of the sub-pixel units included in each row of the pixel units in each group, and specifying a number n of consecutive rows of pixel units having the same allocation condition of colors; defining n rows of the pixel units as a display unit and defining k display units, and sequentially inverting the display units when k is an even number to make the allocation conditions of colors are identical to the ones when k is an odd number; and presetting activation orders, and driving the pixel units in each group for charging, wherein each activation order corresponds to a charging timing of a sub-pixel for displaying a frame. Further with a driving device of an LCD panel and an LCD device, the problems of horizontal bright/dark lines of a frame of mixed colors occurring in the prior art can be solved.

### CROSS REFERENCE TO RELATED APPLICATIONS

The present application claims priority to Chinese Patent Application No. 201310747837.8, filed Dec. 31, 2013, and entitled “DISPLAYING METHOD AND DRIVING DEVICE OF LCD PANEL AND LCD DEVICE”. The entire contents of the above-mentioned patent application are cited and incorporated herein for reference.

### FIELD OF THE INVENTION

The present invention relates to a technical field of displays, and more particularly to a display method and a driving device of an LCD panel and an LCD device.

### BACKGROUND OF THE INVENTION

For reducing loading of a data cable and a serial cable, the so-called “Flip Pixel” is one of the most common layout ways of an LCD panel. The same data line alternately couples to sub-pixels at the left and right sides thereof. Meanwhile, a so-called “Column Color Filter” accompanies the color filter layout, as shown in FIG. 1. When a frame of mixed colors, e.g. yellow, cyan and magenta, is displayed, so-called “horizontal bright/dark lines” are likely to appear and thus deteriorate the quality of the display. It is even prominent for middle or low gray levels.

A cyan frame (0,64,64) is given as an example, and general row inversion drive is adopted. Please refer to FIG. 2, in which a timing diagram of waveforms in data and gate lines of the cyan frame (0,64,64) is shown. The RGB color segments in the data waveforms correspondingly represent voltages for writing data into the RGB sub-pixels. Due to transmission delay, Data 1, Data 2 and Data 4, which need to switch voltages between high (grey level 64) and low, suffer from insufficient charging, while Data 3 remaining at a high voltage (gery level 64) is sufficiently charged.

Please refer to FIG. 3, which is a diagram reflecting charging conditions of sub-pixels of a cyan frame (0,64,64) in different rows, wherein the symbol “—” indicates no charging; the symbol “▴” indicates insufficient charging; and the symbol “▪” indicates sufficient charging. In Rows 1, 2, 5 and 6, it shows no charging for R, insufficient charging for G, and sufficient charging for B. On the other hand, in Rows 3, 4, 7 and 8, it shows no charging for R, sufficient charging for G, and insufficient charging for B. In general, human eyes are more sensitive to green than to blue, particularly for middle or low grey levels. In other words, the charging condition for G has relatively significant effect. Accordingly, people would view rows 3, 4, 7 and 8 as bright lines while viewing Rows 1, 2, 5 and 6 as dark lines, and thus a “horizontal bright/dark lines” phenomenon occurs.

### SUMMARY OF THE INVENTION

The present invention aims to solve the technical problems and provides a display method and a driving device of an LCD panel and an LCD device, in order to solve the “horizontal bright/dark lines” problems occurring in a mixed color frame of an LCD panel.

For solving the aforementioned problems, a first technical solution adopted by the present invention is a displaying method of an LCD panel. The LCD panel includes a plurality of pixel units allocated in an array, each of the pixel units includes a plurality of sub-pixel units corresponding to a plurality of colors, and the method comprises:

dividing the plurality of pixel units of the LCD panel into a plurality of groups on row basis, each group corresponding to at least one row of the LCD panel, and each group including m rows of the pixel units, where m is a positive integer;

realizing an allocation condition of colors of the sub-pixel units included in each row of the pixel units in each group, and specifying a number n of consecutive rows of pixel units having the same allocation condition of colors, where n is a positive integer;

defining 1˜n rows of the pixel units as a display unit so as to define k display units, and sequentially inverting the display units when k is an even number so as to make the allocation conditions of colors of sub-pixel units in each row of pixel units of the display units are identical to the ones when k is an odd number, wherein m=k×n, and k is a positive integer; and

presetting a plurality of activation orders, and driving the pixel units in each group for charging, wherein each activation order corresponds to a charging timing of a sub-pixel for displaying a frame.

In the method, n is selected from a range [2, 100].

In the method, the plurality of colors include red, green and blue.

In the method, the plurality of activation orders are different.

In the method, the LCD panel is a multi-thin-film triple-gate transistor LCD panel.

For solving the aforementioned problems, a second technical solution adopted by the present invention is a driving device of an LCD panel. The LCD panel includes a plurality of pixel units allocated in an array, each of the pixel units includes a plurality of sub-pixel units corresponding to a plurality of colors, and the driving device comprises:

a scan driver coupled to a plurality of scan lines, the scan driver scanning an allocation condition of colors of the sub-pixel units included in each row of the pixel units of the LCD panel;

a data driver coupled to a plurality of data lines, the data driver transmitting charging voltages of the sub-pixel units, and conducting each polarity inversion of the sub-pixel units; and

a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

In the structure, the plurality of colors include red, green and blue.

In the structure, the plurality of activation orders are different.

In the structure, the LCD panel is a multi-thin-film triple-gate transistor LCD panel.

For solving the aforementioned problems, a third technical solution adopted by the present invention is an LCD device. The LCD device comprises:

an LCD panel, the LCD panel comprising:

a plurality of scan lines parallel to one another;

a plurality of data lines parallel to one another and intersecting the plurality of scan lines;

a plurality of pixel units allocated in an array, each of the pixel units including a plurality of sub-pixel units corresponding to a plurality of colors; and

a driving device, the driving device comprising:
a scan driver coupled to a plurality of scan lines, the scan driver scanning an allocation condition of colors of the sub-pixel units included in each row of the pixel units of the LCD panel;
a data driver coupled to a plurality of data lines, the data driver transmitting charging voltages of the sub-pixel units, and conducting each polarity inversion of the sub-pixel units; and
   a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

In the structure, the plurality of colors include red, green and blue.

In the structure, the plurality of activation orders are different.

In the structure, the LCD panel is a multi-thin-film triple-gate transistor LCD panel.

The implementation of the present invention has the following benefits.

Unlike the layout with the pair of “Flip Pixel” and “Column Color Filter” in the prior art, the present invention adopts the layout with the pair of “Flip Pixel” and “Flip Color Filter”. The same data line is always connected to the sub-pixel units of the same color. Accordingly, the problems of horizontal bright/dark lines of a frame of mixed colors occurring in the prior art can be solved.

### BRIEF DESCRIPTION OF THE DRAWINGS

The embodiments or technical solutions of the present invention will be apparent from the following detailed descriptions with reference to the attached drawings. It is understood that the attached drawings are merely for illustrating the embodiments of the present invention, and for those ordinary in the art, further drawings can be derived from the attached drawings without inventive efforts.

FIG. 1 is a schematic diagram showing the structure of partial units of an LCD panel according to prior art, wherein “Flip Pixel” and “Column Color Filter” are paired in the layout;

FIG. 2 is a timing diagram schematically showing waveforms in data and gate lines of the cyan frame (0,64,64);

FIG. 3 is diagram reflecting charging conditions of sub-pixel units in different rows shown in FIG. 2;

FIG. 4 is a schematic diagram showing the structure of partial units of another LCD panel according to prior art, wherein “Flip Pixel” and “Column Color Filter” are paired in the layout;

FIG. 5 is a flowchart illustrating a display method of an LCD panel according to a first embodiment of the present invention;

FIG. 6 is a diagram schematically illustrating a construction of an LCD panel according to the first embodiment of the present invention;

FIG. 7 is a diagram schematically illustrating a structure of the layout with pairing “Flip Pixel” and “Column Color Filter”;

FIG. 8 is a timing diagram schematically showing waveforms in data and gate lines of the cyan frame (0,64,64) in the LCD panel shown in FIG. 7;

FIG. 9 is a schematic diagram illustrating a structure of a driving device of an LCD panel according to a second embodiment of the present invention; and

FIG. 10 is a schematic diagram illustrating a structure of an LCD device according to a third embodiment of the present invention.

### DETAILED DESCRIPTION OF THE PREFERRED EMBODIMENTS

Hereinafter, detailed descriptions of the invention are given with combined drawings and preferred embodiments.

Referring to FIG. 5 through FIG. 8, an embodiment of a displaying method of an LCD panel according to the present invention is illustrated.

As shown in FIG. 5, a flowchart illustrates a display method of an LCD panel according to a first embodiment of the present invention. The LCD panel in the present embodiment includes a plurality of pixel units allocated in an array. Each pixel unit includes a plurality of sub-pixel units corresponding to a plurality of colors. The displaying method of the LCD panel includes the following.

In Step S501, divide the plurality of pixel units of the LCD panel into a plurality of groups on row basis, each group corresponding to at least one row of the LCD panel, and each group including m rows of the pixel units, where m is a positive integer.

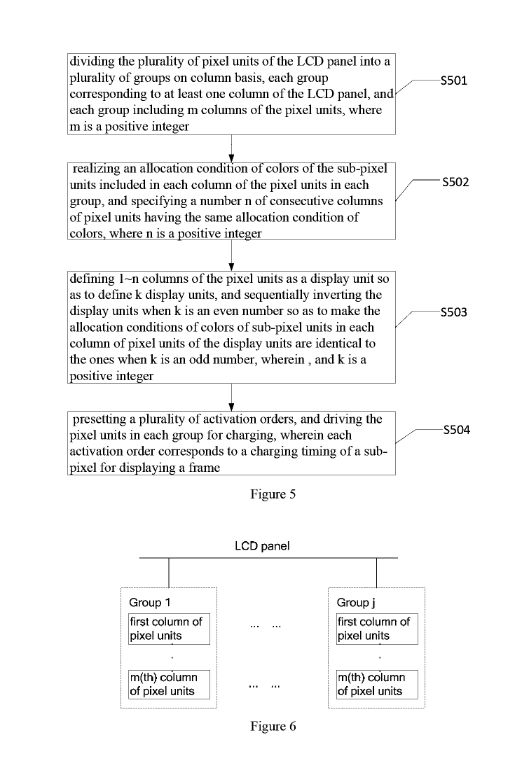

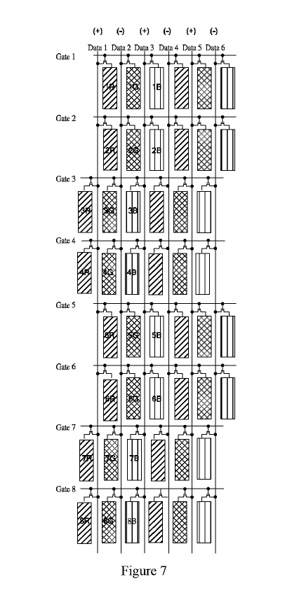

Concretely, the LCD panel is divided into m×j arrays of pixel units. That is, m rows of pixel units constitute one group, and there are j groups in total. Each group corresponds to at least one row of the LCD panel, as shown in FIG. 6, where m is a positive integer, and j is also a positive integer. Each pixel unit of the LCD panel includes a plurality of sub-pixel units, which correspond to a plurality of colors. The plurality of colors include red (R), green (G) and blue (B), and one sub-pixel unit corresponds to one color. The colors of the sub-pixel units are preset before leaving the factory. For each row of pixel units, at least one scan line is used for controlling the writing timing of signal voltages. For each row of sub-pixel units, at least one data line is used to provide signal voltages. The LCD panel is a multi-thin-film triple-gate transistor LCD panel.

In Step S502, realize an allocation condition of colors of the sub-pixel units included in each row of the pixel units in each group, and specify a number n of consecutive rows of pixel units having the same allocation condition of colors, where n is a positive integer;

Concretely, the allocation condition of colors of the sub-pixel units included in each row of the pixel units in each group is realized through a scanning operation of a scan driver. The number n of consecutive rows of pixel units to which the same allocation condition of colors belongs is specified, where n is a positive integer, and selected from the range [2, 100]. Furthermore, n is an initial setting of the LCD panel, and the selected n in each group are the same.

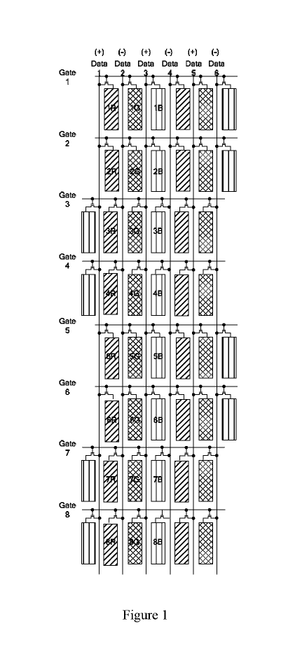

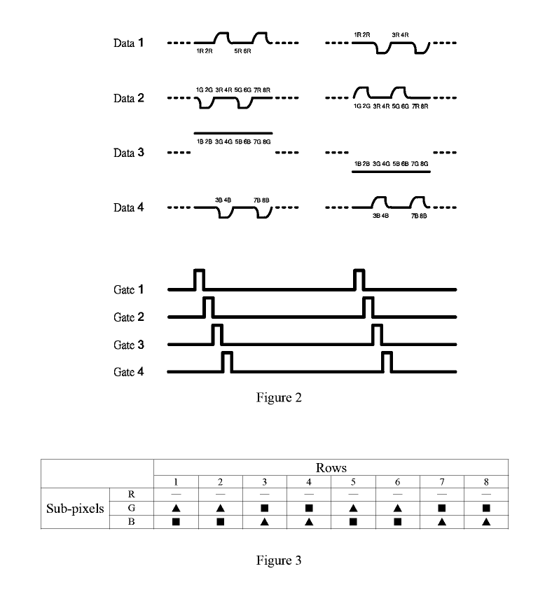

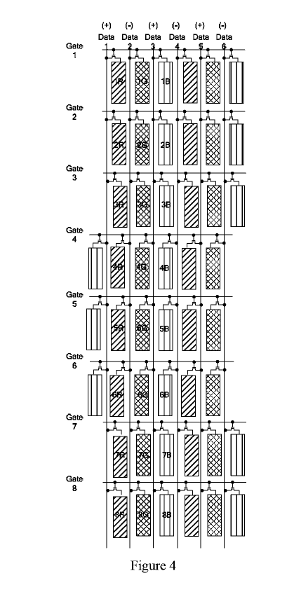

In the prior art as shown in FIG. 1, the number of consecutive rows on the allocation condition of RGB colors of the sub-pixel units is two, next two rows are on the allocation condition of BRG colors of the sub-pixel units, then repeat two rows on the allocation condition of RGB, and two rows on the allocation condition of BGR follow. Thus n=2 is realized. In the prior art as shown in FIG. 4, the number of consecutive rows on the allocation condition of RGB colors of the sub-pixel units is three, next three rows are on the allocation condition of BRG colors of the sub-pixel units, then repeat three rows on the allocation condition of RGB, and three rows on the allocation condition of BGR follow. Thus n=3 is realized. Likewise, n can be divided into different integers and the number of consecutive rows on the same allocation condition of sub-pixel units is realize.

In Step S503, define 1˜n rows of the pixel units as a display unit so as to obtain k display units, and sequentially invert the display units when k is an even number so as to make the allocation conditions of colors of sub-pixel units in each row of pixel units of the display units are identical to the ones when k is an odd number, wherein m=k×n, and k is a positive integer.

Concretely, 1˜n rows of the pixel units are defined as a display unit, and a group is divided into a plurality of display units, each of which is configured as an array based on m=k×n, thereby obtaining k display units. The display units are sequentially inverted by a data driver when k is an even number so as to make the allocation conditions of colors of sub-pixel units in each row of pixel units of the display units are identical to the ones when k is an odd number. Meanwhile, each signal line connects only to the sub-pixel units which are of the same color. The sub-pixel units of the same color in the group, which are coupled to the same signal line, are the ones at one side of the signal line when k is an odd number, and are the ones at the other side of the signal line when k is an even number.

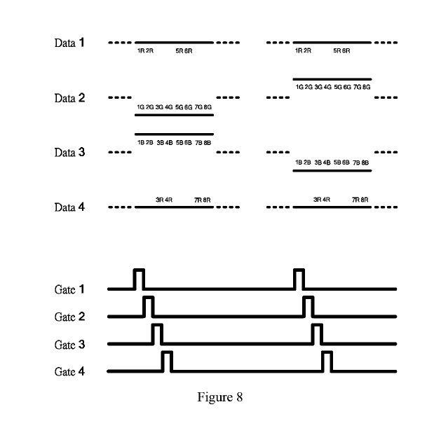

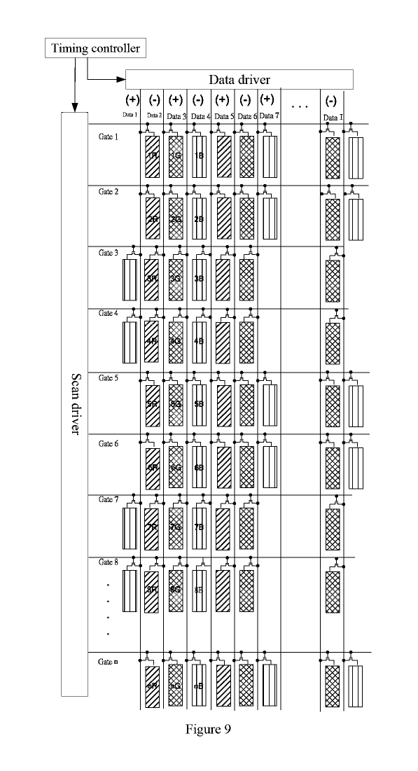

In FIG. 1, where n=2, a group is divided into a number k of two-row-based display units. If k is an odd number, the display unit includes two rows of pixel units with RGB sub-pixel units. If k is an even number, the display unit includes two rows of pixel units with BRG sub-pixel units. The display units under an even number k are sequentially inverted into the display units under an even number k. That is, the two rows of pixel units with BRG sub-pixel units are inverted into two rows of pixel units with RGB sub-pixel units. Please refer to FIG. 7 and FIG. 8. After the layout with the pair of “Flip Pixel” and “Flip Color Filter” are accomplished, Data 1 through Data 4 may remain at a high voltage (grey level 64) to be charged sufficiently. While the sub-pixel units of the same color in the group, which are coupled to the same signal line, are the right-side ones when k is an odd number, the sub-pixel units of the same color in the group, which are coupled to the same signal line, are the left-side ones when k is an even number. Likewise, as shown in FIG. 4, the three rows of pixel units with BRG sub-pixel units are inverted into three rows of pixel units with RGB sub-pixel units. And so forth, n rows of pixel units with BRG sub-pixel units are inverted into n rows of pixel units with RGB sub-pixel units.

In Step S504, preset a plurality of activation orders, and drive the pixel units in each group for charging, wherein each activation order corresponds to a charging timing of a sub-pixel for displaying a frame.

Concretely, a plurality of activation orders are preset, and the pixel units in each group are driven for charging, wherein each activation order corresponds to a charging timing of a sub-pixel for displaying a frame. The signal lines provide signal voltages for each row of sub-pixel units according to the preset activation orders, wherein the plurality of activation orders are different. In the LCD panel, the activation orders of j groups may be different. Different rows of sub-pixel units in the same group may also have different charging timings. If the activation order of a group is red-green-blue, and the activation order of another group is blue-green-red, visual unifying effect can be achieved and color cast can be ameliorated by simultaneously activating the red sub-pixel of the former and the green sub-pixel of the latter.

In an embodiment of the present invention, the layout with the pair of “Flip Pixel” and “Flip Color Filter” is adopted. By inverting the pixel units with different allocation conditions of colors of sub-pixel units, the same data line is always connected to the sub-pixel units of the same color. Accordingly, the problems of horizontal bright/dark lines of a frame of mixed colors occurring in the prior art can be solved.

The implementation of the present invention has the following benefits.

Unlike the layout with the pair of “Flip Pixel” and “Column Color Filter” in the prior art, the present invention adopts the layout with the pair of “Flip Pixel” and “Flip Color Filter”. The same data line is always connected to the sub-pixel units of the same color. Accordingly, the problems of horizontal bright/dark lines of a frame of mixed colors occurring in the prior art can be solved.

As shown in FIG. 9, it is a schematic diagram illustrating a structure of a driving device of an LCD panel according to a second embodiment of the present invention. The LCD panel in the present embodiment includes a plurality of pixel units allocated in an array, and each of the pixel units includes a plurality of sub-pixel units corresponding to a plurality of colors. The driving device of the LCD panel includes:

a scan driver coupled to a plurality of scan lines, the scan driver scanning an allocation condition of colors of the sub-pixel units included in each row of the pixel units of the LCD panel;

a data driver coupled to a plurality of data lines, the data driver transmitting charging voltages of the sub-pixel units, and conducting each polarity inversion of the sub-pixel units; and

a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

In the driving device of the LCD panel provided according to the embodiment of the present invention, the LCD panel is a multi-thin-film triple-gate transistor LCD panel. The scan driver of the driving device of the LCD panel sequentially scans each row of pixel units Gate 1 to Gate m, and realizes the allocation condition of colors of the sub-pixel units in each row of pixel units. Only one row of pixel units is scanned at one time. The plurality of colors include red, green and blue.

The data driver of the driving device of the LCD panel adopts row inversion drive to drive data lines Data 1 through Data I. In a first frame scan period, the data driver supplies a video signal of positive polarity to the sub-pixel units coupled to odd-numbered data lines (Data 1, Data 3, etc.), and the data driver supplies a video signal of negative polarity to the sub-pixel units coupled to even-numbered data lines (Data 2, Data 4, etc.). In a second frame scan period, the data driver inverts the video signal so as to supply the video signal of negative polarity to the sub-pixel units coupled to the odd-numbered data lines (Data 1, Data 3, etc.), while supplying the video signal of positive polarity to the sub-pixel units coupled to even-numbered data lines (Data 2, Data 4, etc.). Accordingly, the data driver can practice the dot inversion of the video signal.

The timing controller of the driving device of the LCD panel controls the scan driver and the data driver, and presets a plurality of activation orders to drive the charging of the pixel units, wherein each of the plurality of activation orders corresponds to a charging timing of a sub-pixel unit for displaying a frame. The plurality of activation orders may be different.

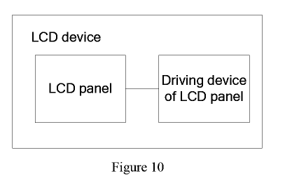

Further refer to FIG. 10, which is a schematic diagram illustrating a structure of an LCD device according to a third embodiment of the present invention. The LCD device according to the embodiment of the present invention comprises:

an LCD panel, the LCD panel comprising:

a plurality of scan lines parallel to one another;

a plurality of data lines parallel to one another and intersecting the plurality of scan lines;

a plurality of pixel units allocated in an array, each of the pixel units including a plurality of sub-pixel units corresponding to a plurality of colors; and

a driving device, the driving device comprising:
a scan driver coupled to a plurality of scan lines, the scan driver scanning an allocation condition of colors of the sub-pixel units included in each row of the pixel units of the LCD panel;
a data driver coupled to a plurality of data lines, the data driver transmitting charging voltages of the sub-pixel units, and conducting each polarity inversion of the sub-pixel units; and
   a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

In the structure, the plurality of colors include red, green and blue.

In the structure, the plurality of activation orders are different.

In the structure, the LCD panel is a multi-thin-film triple-gate transistor LCD panel.

It is understood by those who are ordinary in the art that all or partial steps in the method of the embodiment of the present invention can be implemented with a program which instructs associated hardware to do the work. The program can be stored in a computer accessible storage media. The storage media, for example, are ROM/RAM, magnetic disc, optical disc, and so on.

Those disclosed above are only preferred embodiments according to the present invention and should not be used for limiting the scope of the invention. All the equivalent variations are considered within the scope of the invention.

What is claimed is:

1. A displaying method of an LCD panel, the LCD panel including a plurality of pixel units allocated in an array, each of the pixel units including a plurality of sub-pixel units corresponding to a plurality of colors, and the method comprising:
dividing the plurality of pixel units of the LCD panel into a plurality of groups on row basis, each group corresponding to at least one row of the LCD panel, and each group including m rows of the pixel units, where m is a positive integer;
realizing an allocation condition of colors of the sub-pixel units included in each row of the pixel units in each group, and specifying a number n of consecutive rows of pixel units having the same allocation condition of colors, where n is a positive integer;
defining 1˜n rows of the pixel units as a display unit so as to define k display units, and sequentially inverting the display units when k is an even number so as to make the allocation conditions of colors of sub-pixel units in each row of pixel units of the display units are identical to the ones when k is an odd number, wherein m=k×n, and k is a positive integer; and
presetting a plurality of activation orders, and driving the pixel units in each group for charging, wherein each activation order corresponds to a charging timing of a sub-pixel for displaying a frame.

2. The method according to claim 1, wherein n is selected from a range [2, 100].

3. The method according to claim 1, wherein the plurality of colors include red, green and blue.

4. The method according to claim 1, wherein the plurality of activation orders are different.

5. The method according to claim 1, wherein the LCD panel is a multi-thin-film triple-gate transistor LCD panel.

6. A driving device of an LCD panel, the LCD panel including a plurality of pixel units allocated in an array, each of the pixel units including a plurality of sub-pixel units corresponding to a plurality of colors, and the driving device comprising:
a scan driver coupled to a plurality of scan lines, the scan driver scanning an allocation condition of colors of the sub-pixel units included in each row of the pixel units of the LCD panel;
a data driver coupled to a plurality of data lines, the data driver transmitting charging voltages of the sub-pixel units, and conducting each polarity inversion of the sub-pixel units; and
a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

7. The driving device according to claim 6, wherein the plurality of colors include red, green and blue.

8. The driving device according to claim 6, wherein the plurality of activation orders are different.

9. The driving device according to claim 6, wherein the LCD panel is a multi-thin-film triple-gate transistor LCD panel.

10. A liquid crystal display device, comprising:
an LCD panel, the LCD panel comprising:
a plurality of scan lines parallel to one another;
a plurality of data lines parallel to one another and intersecting the plurality of scan lines;
a plurality of pixel units allocated in an array, each of the pixel units including a plurality of sub-pixel units corresponding to a plurality of colors; and
a driving device, the driving device comprising:
a scan driver coupled to a plurality of scan lines, the scan driver scanning an allocation condition of colors of the sub-pixel units included in each row of the pixel units of the LCD panel;
a data driver coupled to a plurality of data lines, the data driver transmitting charging voltages of the sub-pixel units, and conducting each polarity inversion of the sub-pixel units; and
a timing controller, the timing controller controlling the scan driver and the data driver, and presetting a plurality of activation orders to drive the charging of the pixel units, wherein each of the plurality of activation orders corresponds to a charging timing of a sub-pixel unit for displaying a frame.

11. The liquid crystal display device according to claim 10, wherein the plurality of colors include red, green and blue.

12. The liquid crystal display device according to claim 10, wherein the plurality of activation orders are different.

13. The liquid crystal display device according to claim 10, wherein the LCD panel is a multi-thin-film triple-gate transistor LCD panel.
